(19) United States
(12) Patent Application Publication
(10) Pub. No.: US 2004/0003265 A1
(43) Pub. Date: Jan. 1, 2004

(54) Secure method for BIOS flash data update

(75) Inventors: Joseph Wayne Freeman, Raleigh, NC (US); Steven Dale Goodman, Raleigh, NC (US); Randall Scott Springfield, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/180,796

(22) Filed: Jun. 26, 2002

(51) Int. Cl. G06F 12/14

(52) U.S. Cl. 713/191

(57) ABSTRACT

The disclosed methods enable users to securably modify BIOS data blocks within an EEPROM to update and/or verify non-executable data without requiring that the entire EEPROM and segments thereof be available for open access.

### BACKGROUND OF THE INVENTION

1. The Field of the Invention

The invention relates to the field of personal computer code, and more particularly to the ability to securely access and modify the Basic Input Output System (BIOS) code, that is typically stored in a Flash Electrically-Erasable-Programmable-Read-Only-Memory (EEPROM) for modification.

2. Background of the Art

Nearly every modern personal computer system is sold with Basic Input Output System (BIOS) code, but only recently have manufacturers of BIOS code provided mechanisms for enabling users of personal computers to access BIOS code. BIOS is an embedded code storage application of the personal computer, and more particularly is a low level code interfacing the operating system to the specific hardware implementation. BIOS is typically stored in a flash Electrically-Erasable-Programmable-Read-Only-Memory (EEPROM) that in turn is mounted on the main system board of the personal computer. The BIOS of a main system board is software stored on an EEPROM chip which helps the main system board to function correctly and communicate with devices on the board surfaces and also secondary devices and software protocols that are attached to or running on the main system board respectively.

Typical functions of the BIOS code include the initialization of disk drives (including floppy, hard, and compact), setting control registers settings and the initialization of the video and graphical interfaces. The BIOS is specifically configured for each PC based on the presence of specific hardware and the current version or manufacturer of the hardware. Often, when the hardware of the personal computer is updated or modified, the BIOS code may need to be upgraded to properly recognize and initialize the new hardware. Typically, an updated BIOS can be flashed, by the user, to the Flash Read-Only Memory (ROM), after the user has replaced or upgraded a component to the PC.

On occasion, it may become necessary to update the BIOS image files on a personal computer in order to make allowance for modifications to the personal computer—such as the addition or replacement of existing components with those of newer processors, newer operating systems, or to add functionality or capability such as by providing enhanced device compatibilities, additional features or increased performance and stability functions. In order to update the BIOS to reflect these modifications, or to update the BIOS, typically, the EEPROM of the personal computer undergoes a flashing process (often by a flashing utility tool) whereby the existing BIOS code is erased and a new code is written to the BIOS EEPROM chip. As used herein, the generic process of erasing and writing code is “flashing”.

The Flash BIOS often allows a motherboard manufacturer to add features to a BIOS for hardware and settings that were not typically considered or readied when the motherboard was manufactured, such as larger hard drives, faster CPUs, even specialty devices. In other situations a Flash BIOS can even be offered to correct errors in the code of the original BIOS.

Examples of other attempts to prevent unauthorized accesses to updating or upgrading BIOS code include the creation of a system-level file having ownership and permission characteristics which define files having a “sticky bit” assigned to prevent users from deleting these files. Typically, a “sticky bit” (also known as “sticky logic”) is a control bit that is set in relation to a selected file such that the bit is only cleared at the “power on” activity. For example, in one hardware implementation, a section of the EEPROM may be locked in 64 kb blocks, such that the authorization to write to locked blocks is cleared only after a successful boot sequence. In another exemplary implementation, a user at a group level may set a series of files with a sticky bit such that only the group owner can change the mode of the files In a software implementation, a program executable may create a file so that upon boot a /tmp directory will always have the sticky bit set mode at 1777. In a further implementation, such as that offered with certain chipsets by Intel Corporation (Santa Clara, Calif.) by example, a system management interrupt (SMI) is activated whenever an attempt to write to the EEPROM is detected. Unfortunately, these methods are inadequate where the EEPROM is comprised of code other than executable BIOS code and/or where a user or system administrator has an objective of preventing one from writing to the entire EEPROM.

Additionally, requirements to store data that is not executable BIOS code in the EEPROM have also recently emerged, such as those requirements associated with Boot Integrity Services (BIS), extended system configuration data (ESCD), unique customer data strings for inventory controls and/or start-up screen images, and text strings in the BIOS, for example. More specifically, for instance, for ESCD, an area of memory, typically not exceeding 32 kilobytes in size, is accessed each time the boot sequence is initiated and this area must be writeable at run-time so it may be utilized by an operating system, such as Microsoft® Windows operating systems, as non-volatile random-access memory (NVRAM) for plug and play (PNP) device information which may also be part of the PNP BIOS.

However, given the present state of technology, there is an ever-increasing reason to now modify the data that is not executable BIOS code (as used herein “non-executable data”) in the EEPROM. At present, to modify the non-executable data, there are generally two methods that are employed. The first method requires that the entire EEPROM be flashed, and the second method enables an update program (e.g., BIS update program) to have access to the entire EEPROM. Both of these methods have proven to be inconvenient and disruptive to customers and users of the personal computer, and in particularly for the latter situation, such methods have been shown to be susceptible to viral infiltration.

With the increase in distributed networks, remote wake-up and remote-access capabilities, and the abilities of PCs to link to each other and to link to various networks, as well as the continued interest in having non-executable BIOS code present in the EEPROM, there exists a need to ensure that BIOS updates are both intentional and authorized, as an unauthorized or intentionally viral modification to a personal computer's BIOS image could not only render the personal computer unable to boot, but could also destroy data present, provide a mechanism for damage across a networked system, create an unauthorized release of confidential data, set a covert software agent, and similar. Although historically, a PC could be “secured” by physical isolation. Today's networked environment, however, makes such total isolation impractical. Therefore, techniques that enhance the security of BIOS updates and upgrades, particularly by limiting access to specific segments of the EEPROM, are desirable.

As used herein the terms “BIOS”, “BIOS code”, “BIOS image files” and “system BIOS” are used interchangeably and are intended to have similar meanings and uses in relation to functions and characteristics associated with BIOS. As used herein the terms “personal computer,” “computer,” “PC,” and “server,” are used interchangeably and are intended to have similar meanings and uses in relation to functions and characteristics associated with electronic information handling systems.

### SUMMARY OF THE INVENTION

Therefore, what is needed is a method that allows for a limited access to specific segments of the non-executable data present in the EEPROM without requiring that the entire EEPROM be unlocked and available to be accessed or flashed. Such a method should provide a security means for detecting unauthorized attempts for modification to data elements within the segments of the EEPROM having non-executable data. A method according to the present invention prompts for an authorization and a hash value verification before it permits flashing replacement data image.

One embodiment of the present invention is directed to a method for allowing segments of an EEPROM resident therein to be selective accessed for updating certain non-executable data in predetermined data blocks for said selected segments of the EEPROM. In one aspect of the present invention, a method for securably updating predetermined segments of non-executable data in an EEPROM having locked segments, comprising the steps of: issuing a user's unlock request to modify non-executable data present in one or more predetermined segments to be updated of the EEPROM, assessing said user's unlock request by an authorization means, wherein if said user's unlock request is authenticated by said authorization means, unlocking one or more predetermined segments to be updated, and updating non-executable data of said one or more predetermined segments to be updated, is provided for.

Another embodiment of the present invention is directed to a method to a method to securably program one or more selective segments of non-executable data in an EEPROM having locked segments, comprising the steps of: identifying selective segments of an EEPROM to be programmed, issuing a program command comprising a data area identifier and a hash value of replacement data, verifying said program command with an authentication means, generating a first set of hash values for data blocks for each segment, and generating a first hash aggregate representative of said first set of hash values, unlocking one or more selective segments for programming of non-executable data, programming said non-executable data of said one or more selective segments with replacement data, and generating a second set of hash values for data blocks for each segment subsequent to the step of programming, and generating a second hash aggregate representative of said second set of hash values, verifying said programming step modified only said selected non-executable data of said one or more selective segments by comparing first hash aggregate with second hash aggregate.

In another embodiment of the present invention, a system to notify a user of an existing security violation upon powering on a user's system having an EEPROM, comprising the steps of: calculating a hash value for each data object in a segment of the EEPROM upon powering on, determining a second hash aggregate representative of all calculated hash values, comparing hash aggregate with a first hash aggregate, stored in a storage means, and determined during user's prior update session wherein non-executable data for one or more predetermined segments was modified, and in response to said comparing step, notifying user of security breach if first hash aggregate value is different than second hash aggregate value, is provided for.

### BRIEF DESCRIPTION OF THE DRAWINGS

Other aspects, features, and advantages of the present invention will become more fully apparent from the following detailed description, the appended claims, and the accompanying drawings in which:

FIG. 1 is a block diagram of a flash segment with four data areas in a preferred embodiment of the present invention.

FIG. 2 is a diagram of an update process for non-executable data in a flash module in a preferred embodiment of the present invention.

FIG. 3 is a diagram of a data area update verification process following a flash update for a subsequent power cycle in a preferred embodiment of the present invention.

### DETAILED DESCRIPTION OF THE PREFERRED EMBODIMENTS

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings.

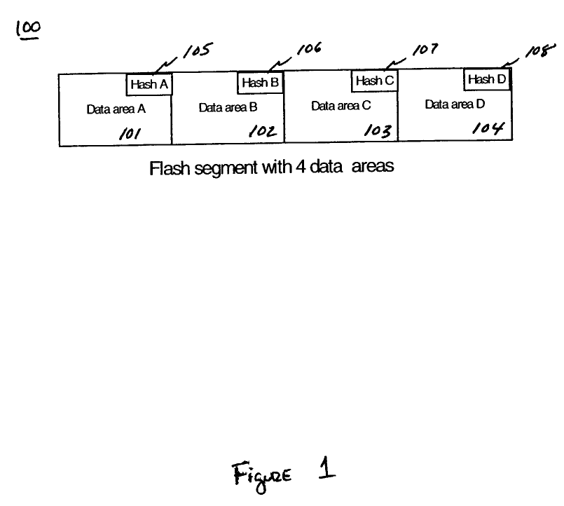

FIG. 1 is a block diagram of a flash segment (100) with four data areas (101, 102, 103, 104) wherein each data area has a hash values (105, 106, 107, 108, respectively) for a preferred embodiment of the present invention. A flash segment is typically 64 Kb in size, is comprised of data blocks, and each flash segments may be locked or unlocked by appropriate command calls. Hash values are determined for each data block and are specific to the data therein, respectively. For the present invention, the hash values of each data block will be stored in any storage means, such as, for example, a boot block, a system file area, or a Trusted Platform Module (TPM). For the present invention, it is preferred that the non-executable data is selectively located into one or more segments such that said one or more segments of an EEPROM will be non-executable code specific, although the present invention is not so limited. In this manner, where the non-executable code is configured to reside on one or more predetermined segments, it is possible to increase performance times and update procedures using the present method. In a particular scenario, a user may be interested in updating non-executable data residing in data blocks 102 and 104 of segment 100 (as shown in FIG. 1). Segment 100 is one of a plurality of segments, not shown, in an EEPROM. Typically, a system management interrupt (SMI) is activated to lock or unlock EEPROM segments whenever an attempt to write to the EEPROM is detected.

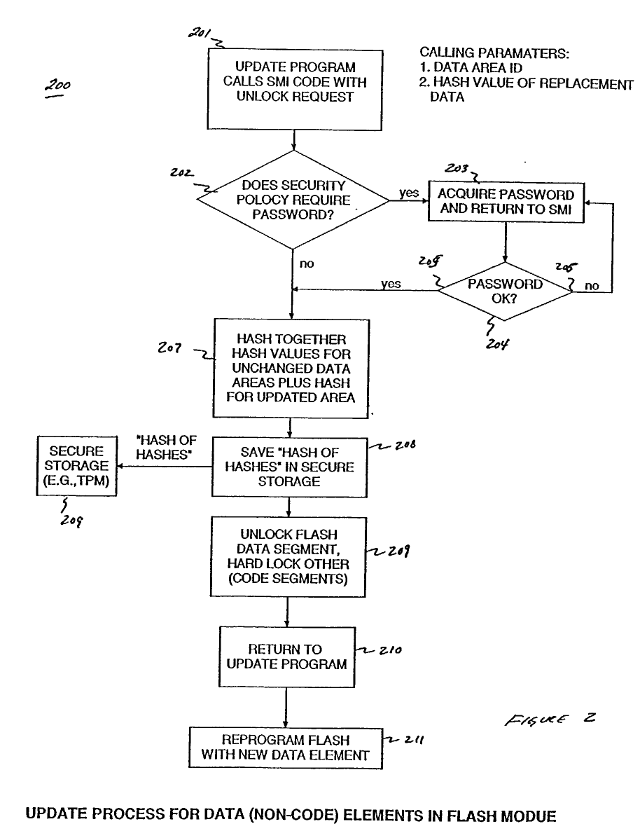

FIG. 2 is a diagram of an update process (200) for non-executable data in a flash module in a preferred embodiment of the present invention. From FIG. 2, a user issues an unlock request (201) to modify non-executable data present in one or more predetermined segments to be updated of the EEPROM. In a preferred embodiment, the user's request includes an identification of the data area to be updated (e.g., data block A (101) and the hash value of replacement data (i.e., a value calculated based upon certain characteristics and/or values of the data being used to replace the identified non-executable data). Typically, as stated previously, a system management interrupt (SMI) is activated to lock or unlock EEPROM segments whenever an attempt to write to the EEPROM is detected, and in a preferred embodiment of the present invention, an unlock request is issued by calling SMI code, although the present invention is not so limited.

A user security authorization (202) such as a password verification or other unique identifier is requested for verification (203); once received the password is authenticated (204) and the update program continues if the authentication is proven successful (205) or fails is the password is not authenticated (206). Typically, a system administrator or other trusted individual is provided administrative access codes. If the verification is deemed successful, a hash aggregate value is determined (207) for the predetermined hash values of each data block. The hash aggregate is a hash value of data block hash values for fixed (unchanged) data block areas and modified (to be updated) data block areas.

The hash aggregate is saved in a secure storage means (208), such as a system file, a boot record, a TPM (209), or similar. The hash aggregate is used to during a post-update verification process to ensure that only the data requested to be updated was updated and that the integrity of other data blocks remains intact.

Once the hash aggregate is determined and saved, the one or more predetermined segments of the EEPROM having the data blocks to be updated is unlocked and the remaining unaffected segments of the EEPROM either remain locked or are hard-locked (209). The process of hard-locking the unaffected data segments is an additional security provision that mitigates the risk of corrupting data blocks with segments that were not initially requested to be updated by the user's request. Once the selected segments are unlocked, the update program is instantiated (210) and the affected data blocks are updated and/or programmed per the user's request (211).

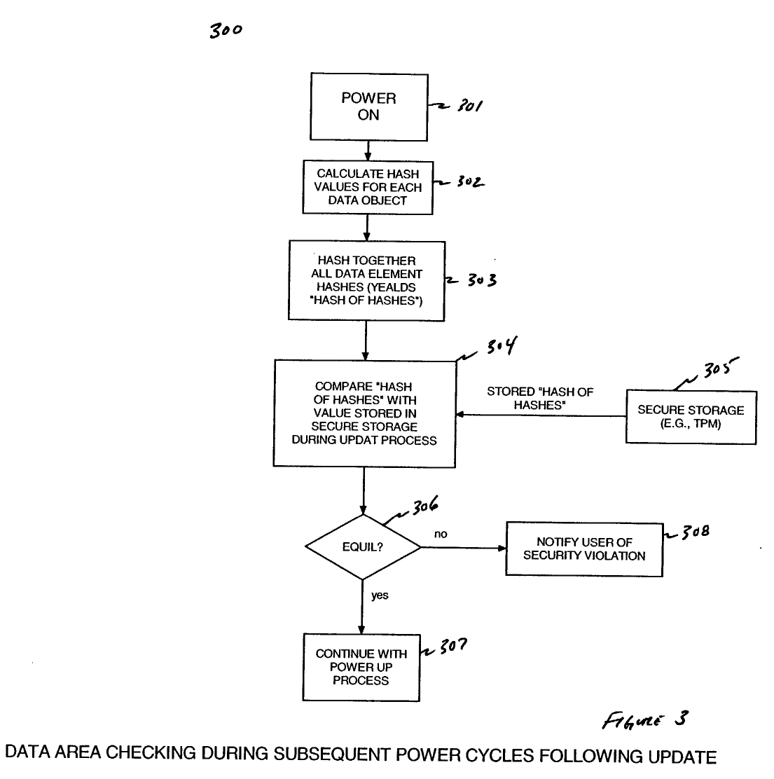

FIG. 3 is a diagram of a data area update verification process (300) following a flash update for a subsequent power cycle in a preferred embodiment of the present invention. In one aspect of the present invention, following power on by a user (301), a hash value is determined for each data block of each segment of the EEPROM (302). A boot hash aggregate is determined from the hash values determined on boot, such that the boot hash aggregate is directly related to the hash values for each data block of each segment (303). The boot aggregate hash is then compared with the stored hash aggregate (305) determined prior to the update process (reference 208 of FIG. 2) to verify that the updated data affected only the data blocks per the user's request at 304. The two hash aggregate values are compared at 306 and if equivalent, the power on process continues (307) and if the comparison demonstrates that the values are not equivalent, the user is notified of a potential security violation (308).

The present invention also has other possibilities such as using the methods for Video BIOS and SCSI BIOS. It is evident that the invention is suitable for use under these and other circumstances, as non-executable data to be updated or new video or SCSI BIOS could be implemented without the requirement to modify the underlying BIOS code portions, and since the present invention is configurable and adaptable for specific situations.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. A method for securably updating predetermined segments of non-executable data in an EEPROM having locked segments, comprising the steps of:
issuing a user's unlock request to modify non-executable data present in one or more predetermined segments to be updated of the EEPROM,
assessing said user's unlock request by an authorization means,
wherein if said user's unlock request is authenticated by said authorization means,
unlocking one or more predetermined segments to be updated, and
updating non-executable data of said one or more predetermined segments to be updated.

2. The method of claim 1, wherein said authorization means includes verification of an authorized password from a user.

3. The method of claim 1, further comprising the step of generating a hash value for each data block of each segment and generating a hash aggregate representative of determined hash values.

4. The method of claim 3, further comprising the step of storing said hash aggregate in a storage means.

5. The method of claim 4, wherein said storage means is a Trusted Platform Module (TPM).

6. A method to securably program one or more selective segments of non-executable data in an EEPROM having one or more locked segments, comprising the steps of:
identifying selective segments of an EEPROM to be programmed,
issuing a program command comprising a data area identifier and a hash value of replacement data,
verifying said program command with an authentication means,
generating a first set of hash values for data blocks for each segment, and
generating a first hash aggregate representative of said first set of hash values,
unlocking one or more selective segments for programming of non-executable data,
programming said non-executable data of said one or more selective segments with replacement data, and
generating a second set of hash values for data blocks for each segment subsequent to the step of programming, and generating a second hash aggregate representative of said second set of hash values,
verifying said programming step modified only said selected non-executable data of said one or more selective segments by comparing first hash aggregate with second hash aggregate.

7. The method of claim 6, wherein at least the one or more segments of EEPROM comprising the non-executable data are initially locked.

8. The method of claim 6, wherein a user request is issued to identify the selective segments of an EEPROM to be programmed.

9. The method of claim 6, wherein said first hash aggregate is stored in a storage means.

10. The method of claim 6, wherein said second hash aggregate is determined in a subsequent user session.

11. The method of claim 6, wherein said authentication means requires a password that is stored in a nonvolatile RAM.

12. The method of claim 11, wherein said password is an administrator password.

13. The method of claim 9, wherein said storage means is a TPM.

14. A system to notify a user of an existing security violation upon powering on a user's system having an EEPROM, comprising the steps of:
calculating a hash value for each data object in a segment of the EEPROM upon powering on,
determining a second hash aggregate representative of all calculated hash values,
comparing hash aggregate with a first hash aggregate, stored in a storage means, and determined during user's prior update session wherein non-executable data for one or more predetermined segments was modified,
and in response to said comparing step,
notifying user of security breach if first hash aggregate value is different than second hash aggregate value.
